(19) United States
(12) Patent Application Publication
(10) Pub. No.: US 2007/0005351 A1
(43) Pub. Date: Jan. 4, 2007

(54) Method and system for bandwidth expansion for voice communications

(76) Inventors: Harsha M. Sathyendra, Gainsville, FL (US); Ismail Uysal, Gainesville, FL (US); John G. Harris, Gainesville, FL (US); Marc A. Boillot, Plantation, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/171,608

(22) Filed: Jun. 30, 2005

(51) Int. Cl. G10L 19/12

(52) U.S. Cl. 704/223

(57) ABSTRACT

The invention concerns a method (400) and system (100) for bandwidth extension of voice for improving the quality of voice in a communication system. The method can include the steps of receiving (412) an unknown voice signal (105), identifying (414) the voice bandwidth (625) of the received unknown voice signal and establishing (418) a region of support (636) in view of the spectral content of the received voice signal. The method can further include the step of selecting (428) a combination of mapping databases (210, 212, 214) from a plurality of mapping databases. Each mapping database can be associated with a predetermined bandwidth extension range for extending the voice bandwidth.

### BACKGROUND OF THE INVENTION

1. Field of the Invention

This invention relates in general to extending voice bandwidth and more particularly, to extending narrowband voice signals to wideband voice signals.

2. Description of the Related Art

The use of portable electronic devices has exploded in recent years. Cellular telephones, in particular, have become quite popular with the public. The primary purpose of cellular phones is for voice communication. A cellular phone operates on voice signals by compressing voice and sending the voice signals over a communications network. The compression reduces the amount of data required to represent the voice signal and the voice bandwidth. For example, the voice bandwidth on a cellular phone is generally band limited to between 300 Hz and 3.4 KHz, whereas natural spoken voice resides mainly within a bandwidth between 20 Hz to 10 KHz. The voice band-limiting process is a necessary step involved in the efficient transmission and reception of digital signals in a cellular communication system.

Fortunately, compressed voice sufficiently preserves the original voice character and intelligibility, even though it does not include all the frequency components of the original data. In particular, voice compression removes the low frequency regions of voice (i.e., below 300 Hz) as well as the high frequency regions of voice (i.e., above 3.4 KHz to 10 KHz). Although voice compression produces a voice signal that is satisfactory for wireless communications, several speech processing techniques have been tested and applied in an attempt to restore the missing low frequency and high frequency voice components to generate a higher-quality signal. To date, however, no technique has been developed that effectively recreates the removed frequency components. Moreover, conventional analog telephones do not implement any compression. As such, they still suffer from similar bandwidth restrictions due to decades-old transmission standards.

### SUMMARY OF THE INVENTION

The present invention concerns a method for bandwidth extension for voice communications. The method can include the steps of receiving an unknown voice signal, identifying the voice bandwidth of the received unknown voice signal and establishing a region of support in view of the spectral content of the received voice signal. The method can also include the step of selecting a combination of mapping databases from a plurality of mapping databases. Each mapping database can be associated with a predetermined bandwidth extension range for extending the voice bandwidth.

As an example, identifying the voice bandwidth can include performing a spectral analysis to determine the voice signal bandwidth of the unknown voice signal based on a spectral energy of the signal. Also, establishing a region of support can include the steps of issuing a request to an underlying object to return a list of sampling frequencies for which the object is capable of supporting, identifying spectral limits based on the returned sampling frequency and determining spectral bands within the spectral limits for extending the voice bandwidth to regions that reside outside the voice bandwidth. Establishing a region of support may further include the step of re-sampling the voice signal at a sampling frequency corresponding to at least one of the returned sampling frequencies.

In one arrangement, the step of selecting a combination of mapping databases can be a sequential operation. This selecting step can further include applying a serial combination of mapped databases to collectively extend the voice bandwidth to a range corresponding to the addition of the selected bandwidth extension ranges. As an example, there can be a first mapping database for the range approximately 0 to approximately 8 KHz, a second mapping database for approximately 8 KHz to approximately 16 KHZ and a third mapping database for approximately 16 KHz to approximately 22 KHz. The three mapping databases may be Gaussian Mixture Models.

The method can also include the steps of acquiring a set of narrowband reflection coefficients that represent the spectral envelope from the voice signal and extending the set of narrowband reflection coefficients to a set of wideband reflection coefficients using the mapping databases for generating a wideband spectral envelope. In addition, a set of reflection coefficients can be converted to a set of cepstral coefficients for reducing a memory storage by compressing a Gaussian full covariance matrix to a diagonal vector of variances.

In another arrangement, the method can further include the steps of extracting a narrowband excitation signal from the voice signal using a set of wideband reflection coefficients and extending the narrowband excitation signal to a wideband excitation signal using modulation and filtering. The method can further include the steps of combining a wideband excitation signal with a wideband spectral envelope to generate a synthetic wideband voice signal, extracting a supplemental wideband voice signal from the synthetic wideband voice signal in the region of support and adding the supplemental synthetic wideband voice signal with the original voice signal to generate a wideband voice signal.

The present invention also concerns a method of extending a set of narrowband reflection coefficients to a set of wideband coefficients for use in voice bandwidth extension. This method can include the steps of generating a low-band excitation, generating a high-band excitation and adding the low-band excitation and the high-band excitation with a narrowband excitation to create a half-band excitation. The method can also include the step of generating a wide-band excitation from the half-band excitation. The step of generating the low-band excitation and the high-band excitation can include the steps of modulating the low-band excitation and the high-band excitation using a cosine multiplication and filtering the low-band excitation and the high-band excitation.

The present invention also concerns a machine readable storage. The machine readable storage can have stored thereon a computer program having a plurality of code sections executable by a portable computing device. The code sections can cause the portable computing device to perform the steps of receiving an unknown voice signal, identifying the voice bandwidth of the received unknown voice signal and establishing a region of support in view of the spectral content of the received voice signal. The code sections can further cause the portable computing device to perform the step of selecting a combination of mapping databases from a plurality of mapping databases. As before, each mapping database can be associated with a predetermined bandwidth extension range for extending the voice bandwidth. The code sections can also cause the portable computing device to perform any of the other method steps recited above.

The present invention also concerns a system for artificially extending the bandwidth of voice. The system can include an evaluation section, a database selector cooperatively coupled to the evaluation section and a bandwidth extension unit cooperatively coupled to the evaluation section and the database selector. The evaluation section can receive an unknown voice signal and can determine an allowable extent of voice bandwidth for the unknown voice signal. The database selector can choose a combination of mapping databases according to the allowable extent of voice bandwidth. In addition, the bandwidth extension unit can extend the voice bandwidth of the unknown voice signal to the allowable extent of voice bandwidth. The bandwidth extension unit can do this by using the combination of mapping databases chosen by the database selector. The system can also include suitable circuitry and software for performing any of the method steps recited above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a system for artificially extending the bandwidth of voice in accordance with an embodiment of the inventive arrangements;

FIG. 2 illustrates some of the components of FIG. 1 in greater detail in accordance with an embodiment of the inventive arrangements;

FIG. 3 illustrates an example of a multi-path excitation stage in accordance with an embodiment of the inventive arrangements;

FIG. 4 illustrates a portion of a method for bandwidth extension of voice in accordance with an embodiment of the inventive arrangements;

FIG. 5 illustrates another portion of a method for bandwidth extension of voice in accordance with an embodiment of the inventive arrangements;

FIG. 6 illustrates several graphs associated with extending bandwidth of a voice signal in accordance with an embodiment of the inventive arrangements; and

FIG. 7 illustrates a system for converting a set of narrowband coefficients to a set of wideband coefficients in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

An objective of voice bandwidth extension is to restore the quality of compressed voice to a level that matches the subjective quality level of the original voice. The invention concerns a method and system for bandwidth extension of voice for improving the quality of voice in a communication system. The method can include the steps of receiving an unknown voice signal, identifying the voice bandwidth from the spectral content of the received unknown voice signal and establishing a region of support in view of the spectral content of the received voice signal. The method can also include the step of selecting a combination of mapping databases from a plurality of mapping databases in which each mapping database can be associated with a predetermined bandwidth extension range for extending the voice bandwidth to the region of support. Through these steps and other processes that will be described below, the bandwidth of the unknown voice signal can be extended.

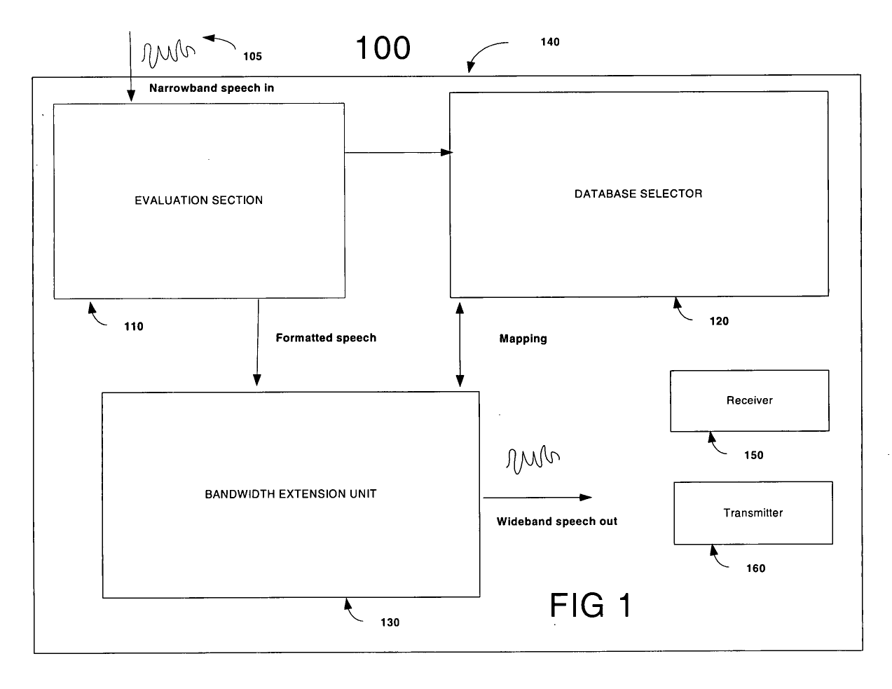

Referring to FIG. 1, an example of a system 100 for artificially extending the bandwidth of voice is shown. In one arrangement, the system 100 can include an evaluation section 110, a database selector 120, which can be cooperatively coupled to the evaluation section 110, and a bandwidth extension unit 130. The bandwidth extension unit 130 can belcooperatively coupled to both the evaluation section 110 and the database selector 120. In one embodiment, the evaluation section 110, the database selector 120 and the bandwidth extension unit 130 can be part of a mobile communications unit 140, like a cellular telephone. In such a case, the mobile communications unit 140 may include a receiver 150 and/or a transmitter 160 for receiving and/or transmitting voice or data signals.

The evaluation section 110 can receive an unknown voice signal 105 and can determine an allowable extent of voice bandwidth for the unknown voice signal 105. This unknown voice signal 105, in view of subsequent processing performed on it, may also be referred to simply as voice signal 105 or re-sampled voice signal 105. The allowable extent of the voice bandwidth can correspond to a region of support. As an example, the database selector 120 can choose a combination of mapping databases (not shown here) according to the allowable extent of voice bandwidth. Also, the bandwidth extension unit 130 can extend the voice bandwidth of the unknown voice signal 105 to the allowable extent of voice bandwidth. For example, the bandwidth extension unit 130 can extend the voice bandwidth of the unknown voice signal 105 using the combination of mapping databases chosen by the database selector 120.

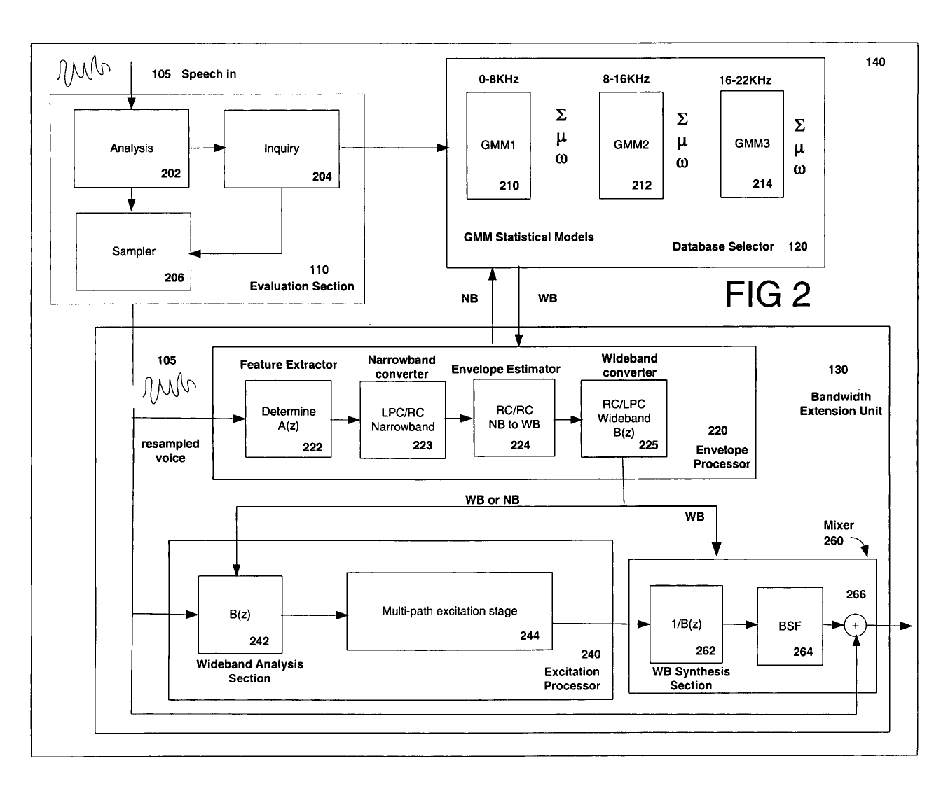

Referring to FIG. 2, a more detailed block diagram of the evaluation section 110, the database selector 120, and the bandwidth extension unit 130 is shown. In one arrangement, the evaluation section 110 can include an analysis module 202, an inquiry module 204 and a sampling module 206. The analysis module 202 can be coupled to the inquiry module 204, which can be coupled to the sampling module 206. Additionally, the sampling module 206 can be coupled to the analysis module 202.

Briefly, the analysis module 202 is capable of identifying the voice bandwidth of the received unknown voice signal 105. The inquiry module 204 is capable of identifying a list of supported sampling rates associated with the system 100, where each supported sampling rate can reveal the extent to which the voice bandwidth can be extended. As an example, the supported sampling rates can be associated with the mobile unit 140. The sampling module 206 can re-sample the unknown voice signal 105 at a sampling rate identified by the inquiry module 204, which can produce a re-sampled voice signal 105. Thus, the evaluation section 110 can effectively 1) analyze the unknown voice signal 105 to determine the voice bandwidth; 2) identify the sampling rates the system 100 can support; 3) determine an allowable extent of voice bandwidth; and 4) re-sample the voice signal 105 at one of the identified sampling rates.

In one arrangement, the database selector 120 can include a plurality of mapping databases 210, 212, and 214, in which each mapping database 210, 212 and 214 can be associated with a predetermined bandwidth extension range for extending the voice bandwidth. The database selector 120 can choose the mapping databases 210, 212 and 214 to selectively extend the bandwidth of the voice signal 105 up to the system-supported bandwidth. In particular, the mapping databases 210, 212 and 214 can provide incremental capabilities for extending voice bandwidth based on the supported system sampling frequencies. This process will be explained in further detail below.

In one arrangement, the bandwidth extension unit 130 can include an envelope processor 220, an excitation processor 240, and a mixing processor 260. The envelope processor 220 can be communicatively coupled to the evaluation section 110 and the database selector 120. The excitation processor 240 can be communicatively coupled to the evaluation section 110 and the envelope processor 220. In addition, the mixing processor 260 can be communicatively coupled to the evaluation section 110, the envelope processor, 220 and the excitation processor 240.

Briefly, the envelope processor 220 can determine a narrowband envelope from the voice signal 105 and subsequently a wideband spectral envelope. As an example and without limitation, the envelope processor 220 can provide a set of wideband coefficients representing a wideband spectral envelope. Using the wideband spectral envelope (e.g., the set of wideband coefficients) provided by envelope processor 220, the excitation processor 240 can determine a narrowband excitation signal from the voice signal 105 to subsequently create a wideband excitation signal. The mixing processor 260 can create a supplemental wideband signal from the wideband excitation signal and wideband spectral envelope, which can then be combined with the voice signal 105 to create a wideband voice signal.

As an example, the envelope processor 220 can include a feature extractor 222, a narrowband converter 223, an envelope estimator 224 and a wideband converter 225. The feature extractor 222 can be communicatively coupled to the sampling module 206 for receiving the re-sampled voice signal 105 and for acquiring a set of linear prediction analysis (LPC) coefficients representing a narrowband spectral envelope of the re-sampled voice signal 105. Further, the narrowband converter 223, which can be communicatively coupled to the feature extractor 222, can convert the set of LPC coefficients into a set of narrowband reflection coefficients.

The envelope estimator 224 can be communicatively coupled to the narrowband converter 223 and can receive the set of narrowband reflection coefficients representing the narrowband spectral envelope. Using the mapping databases 210, 212 and 214, the envelope estimator 224, in conjunction with the database selector 120, can extend the set of narrowband reflection coefficients to a set of wideband reflection coefficients, which can enable the envelope estimator 224 (and the database selector 120) to estimate a wideband spectral envelope from a narrowband spectral envelope. Communicatively coupled to the envelope estimator 224, a wideband converter 225 can convert the wideband reflection coefficients into a set of wideband LPC coefficients.

The excitation processor 240 can include a wideband analysis section 242 and a multi-path excitation stage 244, both of which can be communicatively coupled to one another. The wideband analysis section 242 can be coupled to the sampling module 206 for receiving the re-sampled voice signal 105. Once received, the wideband analysis section 242 can extract a narrowband excitation signal from the re-sampled voice signal 105 using the wideband spectral envelope produced by the envelope estimator 224. As will be discussed later, another approach is to use the narrowband spectral envelope to extract a narrowband excitation signal from the re-sampled voice signal 105. The multi-path excitation stage 244 can generate a wideband excitation signal from the narrowband excitation signal extracted by the wideband analysis section 242.

The mixing processor 260 can include a wideband synthesis section 262, a band-stop filter 264 and an adder 266. The wideband synthesis section 262 can combine the wideband excitation signal provided by the excitation processor 240 together with the wideband envelope provided by the envelope processor 220 to generate a synthetic wideband voice signal. The band-stop filter 264 can suppress the spectral content of the synthetic wideband voice signal within the frequency regions already occupied by the voice signal 105. As a result, the band-stop filter 264 can provide a supplemental wideband voice signal that includes frequency information within the allowable extent of voice bandwidth. The adder 266 can combine the supplemental wideband signal received from band-stop filter 264 with the voice signal from the sampling module 206 to create a wideband voice signal.

Although FIGS. 1 and 2 represent examples of systems and components (both hardware and software) that would enable one to practice the inventive method, it is understood that the invention is not so limited. The method can be practiced in any suitable voice processing system using any suitable combination of components, both software and hardware.

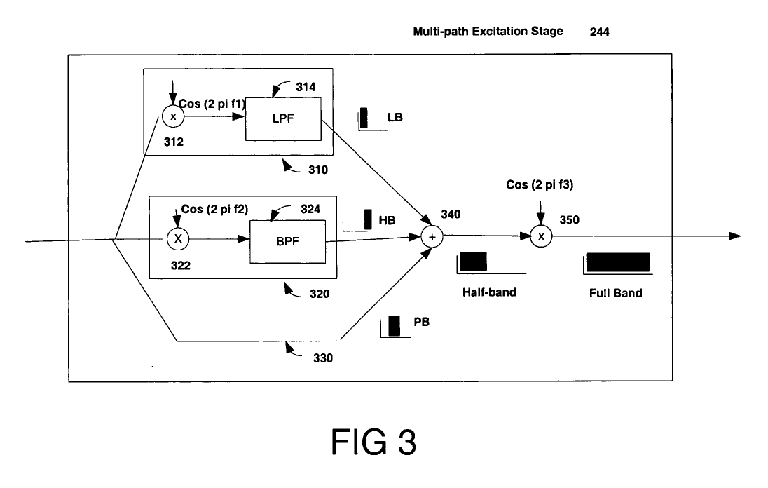

Referring to FIG. 3, an example of a more detailed block diagram of the multi-path excitation stage 244 is shown. It is understood, however, that this particular representation of the multi-path excitation stage 244 is merely one example of such a component. Those of skill in the art will appreciate that other suitable layouts may be employed in the invention.

In one arrangement, the multi-path excitation stage 244 can include a low-band excitation stage 310, a high-band excitation stage 320 and a pass-band excitation stage 330, the combination of which is capable of processing the narrowband excitation signal received from the wideband analysis section 242 (see FIG. 2).

The low-band excitation stage 310 can include a modulator 312 and a low-pass filter 314. The high-band excitation stage 320 can include a modulator 322 and a band-pass filter 324. The pass-band excitation stage 330 can pass the unprocessed narrowband excitation signal. One purpose of the low-band excitation stage 310, the high-band excitation stage 320 and the pass-band excitation stage 330 is to artificially extend the excitation signal to a frequency range identified by the inquiry module 204.

The multi-path excitation stage 244 can also include an adder 340 for summing the low-band, high-band and pass-band excitation signals into a composite half-band excitation signal. The multi-path excitation stage 244 can also have a modulator 350 for artificially extending the half-band excitation to a wideband excitation, which can be considered a full-band or wideband excitation. As noted earlier, the wideband excitation signal generated by the multi-path excitation stage 244 can be combined with a wideband envelope to generate a synthetic wideband voice signal.

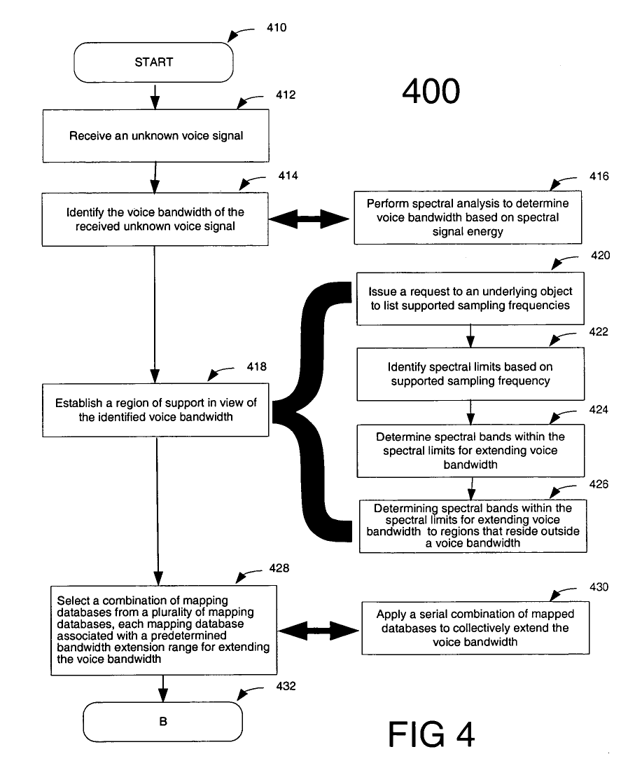

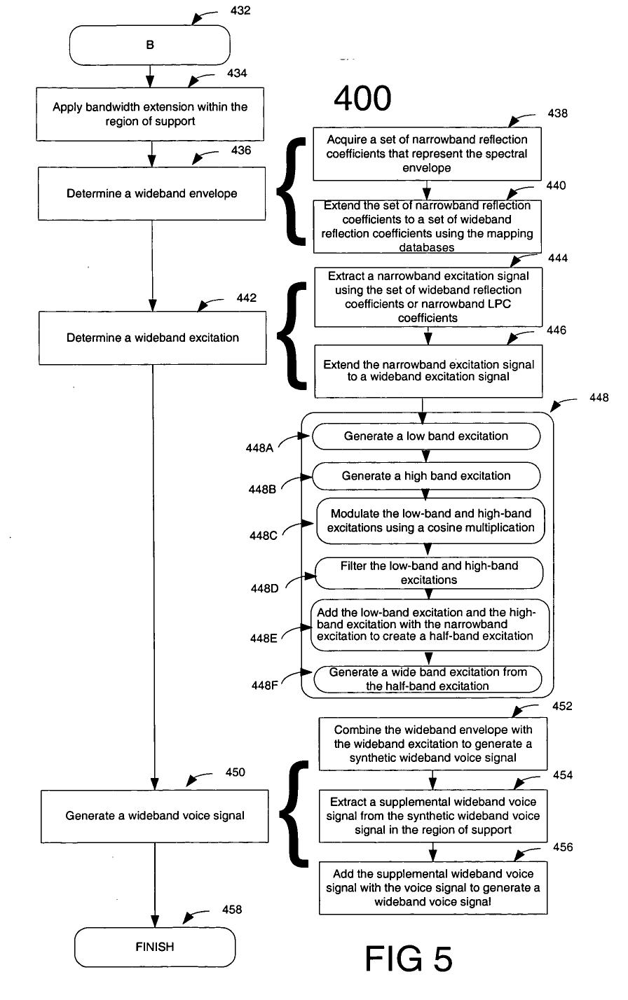

Referring to FIGS. 4-5, a method 400 will be used to explain an example of extending the bandwidth of voice. Although FIGS. 1-3 will be used to help describe the method 400, it should be understood that the method 400 can be implemented in any other suitable device or system using any suitable components. Moreover, the invention is not limited to the order in which the steps are listed in the method 400. In addition, the method 400 can contain a greater or a fewer number of steps than those shown in FIGS. 4-5.

At step 410, the method 400 can start. At step 412, an unknown voice signal can be received. The term “unknown” in this context can mean that the sampling rate or bandwidth of the received voice signal is unknown. At step 414, the voice bandwidth of the received unknown voice signal can be identified. As an example, at step 416, a spectral analysis can be performed on the unknown voice signal to determine a voice signal bandwidth based on the spectral energy.

For example, referring to FIG. 2, the analysis module 202 can receive the unknown voice signal 105 and can determine the unknown voice bandwidth, in accordance with steps 412 and 414. Those of skill in the art will appreciate that there are many different ways to determine the bandwidth of a voice signal, and the invention is not limited to any particular technique.

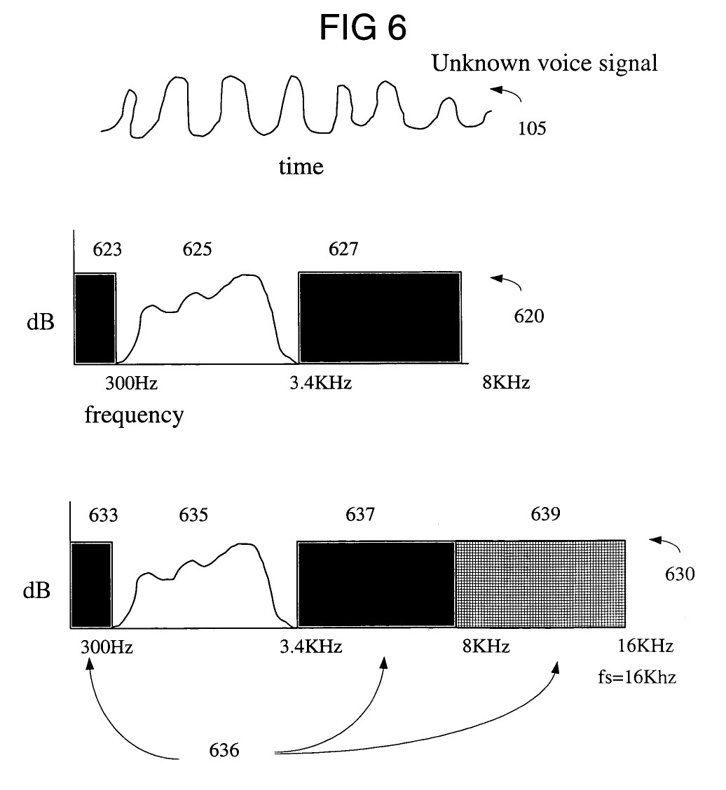

Referring to FIG. 6, an example of a frequency response 620 of the unknown voice signal is shown. The analysis module 202 of FIG. 2 can generate the frequency response 620 and can identify the voice bandwidth based on the distribution of spectral energy. For example, a voice bandwidth 625 of the frequency response 620 may occupy a region between approximately 300 Hz and approximately 3.4 KHz, although other suitable values can be easily substituted in the invention. This voice bandwidth can represent the post-compression bandwidth of the voice signal 105 (i.e., a narrowband voice signal).

The voice signal 105 here may have a sampling frequency of 8 KHZ, which means that spectral content will not be present from 4 KHz to 8 KHz, in view of the Nyquist theorem. Although not constrained by the Nyquist theorem, spectral content may not be present from 0 Hz to 300 Hz or from 3.4 KHz to 4 KHz for the voice signal 105, which is common in many wireless communications systems.

Referring back to the method 400 of FIGS. 4 and 5, at step 418, a region of support in view of the voice bandwidth can be established. As an example, the region of support can describe frequency regions of speech where spectral content may be absent and where voice bandwidth extension can be applied. Steps 420-426 describe one example of how a region of support can be established. In particular, at step 420, a request can be issued to an underlying object to list sampling frequencies that the object is capable of supporting. Knowledge of the sampling frequencies, as determined above, may be required because the sampling rates reveal the extent to which the voice bandwidth can be extended. Spectral limits based on the supported sampling rates can be identified, as shown at step 422. The spectral limits can define the frequency bounds where the system can add spectral content to the voice signal.

At step 424, spectral bands can be determined within the spectral limits for extending voice bandwidth to regions that may reside outside the voice bandwidth of the voice signal. At step 426, the voice signal can be re-sampled at a selected sampling rate corresponding to at least one of the returned sampling frequencies. This process can prepare the frequency range for extending the spectral content within the narrowband voice signal.

For example, referring to FIGS. 2 and 6, the inquiry module 204 can issue a request to an underlying object to list supported sampling frequencies. The underlying object can be a physical device or software interface that provides an ability to perform signal processing and can be aware of the sampling rates that it can support. For example, an audio player device may provide numerous sampling rates, such as 8 KHz for voice, 22.5 KHz for MP3, and 44.1 KHz for a compact disc. As is known in the art, the system bandwidth can then be determined from the sampling frequency using the Nyquist criterion. As such, a sampling frequency of 8 KHz can provide a voice bandwidth of half the sampling frequency, which is 4 KHz.

Given knowledge of the voice bandwidth of the unknown voice signal 105 and the available system bandwidth, the evaluation section 110 can determine regions where spectral content is absent in the voice signal 105. Specifically, the evaluation section 110 can define spectral limits of the frequency bounds where spectral content can be added to the voice signal 105, in accordance with step 422 of the method 400. For example, the spectral limits for the frequency response 625 of the voice signal 105 are demarcated by limits 623 and 627. In this example, this corresponds to lower spectral limits of 0 to 300 Hz (limit 623) and higher spectral limits of 3.4 KHz to 8 KHz (limit 627).

The evaluation unit 110 can also determine spectral bands within the identified spectral limits for determining the extent of voice bandwidth based on the system bandwidth, in accordance with step 424. In one arrangement, the spectral bands can define a region of support 636. The region of support 636 can describe the frequency regions where spectral content can be added to the voice bandwidth, for which there is currently little or no voice frequency content. As such, the region of support 636 inherently describes the allowable extent of voice bandwidth.

For example, the analysis module 202 can perform a spectral analysis of the unknown voice signal 105, which may reveal that the voice bandwidth is between 300 Hz and 3.4 KHz, as seen in the voice bandwidth 625. As is known in the art, the Nyquist theorem states that the sampling rate associated with the unknown voice signal must be at least twice the signal bandwidth, which is a sampling rate of 8 KHz in our example. An inquiry to the underlying object may reveal that sampling rates of 8 KHz, 16 KHz, 22 KHz, and 44 KHz are supported. As an example, at a sampling rate of 8 KHz, not all of the upper region of support (4 KHz to 8 KHz) may be available (though there may be a lower region of support (0 Hz to 300 Hz) and part of an upper region of support (3.4 KHz to 4 KHz).

If the inquiry module 204 identifies a supported higher sampling frequency of 16 KHz, however, an upper region of support is possible. A system-supported sampling rate of 16 KHz suggests that at least a portion of an allowable upper region of support 637 is 4 KHz, or the signal bandwidth for a 16 KHz sampling frequency minus the upper narrowband limit of the voice bandwidth (8 KHz minus 4 Khz). In this example, sampling the voice signal at 16 KHz can allow for the addition of upper spectral content at the upper region of support 637 between 4 KHz and 8 KHz. This additional upper spectral content can supplement lower spectral content that may be added to a lower region of support 633 between 0 to 300 Hz and the spectral content in the upper region of support 637 from 3.4 KHz to 4 KHz.

In this example, the region of support 636 may include the upper region of support 637 and the lower region of support 633. Those of skill in the art will appreciate, however, that the invention is not limited to this example. In particular, the region of support 636 may not include both an upper and lower region of support. In addition, the region of support 636 does not necessarily have to cover the full extent of the identified spectral limits.

As noted earlier, the sampling module 206 can resample the voice signal 105. The evaluation section 110 can select the re-sampling rate that corresponds to one of the identified, system-supported sampling rates. In one arrangement, the evaluation section 110 can provide automatic or manual selection. In a manual selection configuration, the user using the system 100 may select the sampling rate of his or her choosing through, for example, a graphical user interface or any other suitable interface. For example, the user may want high-quality speech and may elect the highest available sampling rate. Alternatively, in the automatic selection configuration, a system provider, such as a wireless carrier, can control the sampling rate. For example, the system provider may want to limit the sampling rate based on a quality of service measure or a cost structure, where the system provider may charge the user a higher service fee for higher quality speech.

The re-sampling by the sampling module 206 in effect establishes the available system bandwidth and prepares the voice signal 105 for bandwidth extension. The re-sampling effectively allows for the extension of the voice bandwidth into the region of support 636. In summary, if the system-supported sampling frequency is higher than the unknown voice sampling frequency, then the signal bandwidth occupied by the unknown voice can be considered narrowband. If the narrowband signal can be extended within any region up to a supported system bandwidth, the signal will be considered a wideband signal. The difference in frequency content between a narrowband signal and a wideband signal may be the region of support. It is understood, however, that the invention is in no way limited to any of the examples recited above with respect to a narrowband or wideband signals or a region of support.

Referring back to FIG. 4, at step 428, a combination of mapping databases can be selected from a plurality of mapping databases in which each mapping database can be associated with a predetermined bandwidth extension range for extending the voice bandwidth. This selection can be considered in view of the region of support. As explained earlier, the region of support can reflect the allowable extent to which the voice bandwidth may be extended. The combination of mapping databases can be selected to collectively add spectral content to the region of support.

The mapping databases can be created such that a first mapping database can provide a first range, a second mapping database can provide a second range starting from the end of the first range, and a third database can provide a third range starting from the end of the second range. In this manner, at step 430, the databases can be serially combined to collectively extend the voice bandwidth to provide spectral content within the region of support.

For illustration, referring to FIGS. 2 and 6 and as explained earlier, a spectral analysis may reveal that the voice bandwidth for a signal at a sampling frequency of 8 KHz is between 500 to 3.4 Khz (see the voice bandwidth 625). The frequencies between 4 KHz and 8 KHz are frequencies where voice cannot be present due to the Nyquist sampling theorem. Hence, the voice bandwidth, in view of the 8 KHz sampling frequency, may only be extended to the lower frequencies, 0 Hz to 300 Hz and a portion of the upper frequencies, 3.4 KHz to 4 KHz. If the voice signal 105 is re-sampled at a higher rate of 16 Khz, for example, the voice bandwidth can be extended from 4 KHz to 8 KHz. In our example, the hatched region 639 denotes a region (8 KHz to 16 KHz) where voice cannot be present due to the Nyquist sampling theorem, based on a 16 KHz sampling rate.

One or more of the mapping databases 210, 212, and 214 can be selected to fill in the lower region of support 633 and the upper region of support 637. For example, the first mapping database 210 can allow for bandwidth extension up to 8 KHz, which can be sufficient for voice sampled at 16 KHz. As another example, for a sampling rate of 22 KHz, the mapping database 210 and the mapping database 212 can be combined to achieve a voice band extension up to 11 KHz, which can help fill in a portion of the hatched region 639. That is, the mapping database 210 can be selected to assist in providing spectral content from 0 Hz to 300 Hz and from 3.4 KHz to 8 KHz, while the mapping database 212 can help fill in the range from 8 KHz to 11 KHz for a sampling frequency of 22 KHz. In view of the higher sampling rate of 22 KHz, a portion of the hatched region 639 may now be part of the region of support 636. As one can see, the selection of a combination of mapping databases can be a sequential operation, although the invention is not necessarily limited to such an arrangement.

In one arrangement, the first mapping database 210 can be associated with a predetermined bandwidth extension range of approximately 0 Hz to approximately 8 KHz, and the second mapping database 212 can be associated with a predetermined bandwidth extension range of approximately 8 KHz to approximately 16 KHz. Additionally, the third mapping database 214 can be associated with a predetermined bandwidth extension range of approximately 16 KHz to approximately 22 KHz.

Of course, those of skill in the art will appreciate that the invention is not limited to these mapping databases 210, 212 and 214. The invention can include any suitable number of mapping databases that are associated with any suitable frequencies. Also, the invention is not limited to mapping databases based on linearly extended frequency extension ranges. For example, the mapping databases could all support the same frequency range but provide various degrees of amplification or suppression across the common frequency range.

Referring to back FIG. 4, the method 400 can continue on to FIG. 5 by step 432. At step 434, the bandwidth extension can be applied within the region of support. Steps 436-456 provide an example of how this process can be performed.

At step 436, a wideband spectral envelope can be created from the voice signal. In particular, the wideband spectral envelope can be determined by estimating the narrowband spectral envelope that can be acquired through feature extraction. For example, at step 438, a set of narrowband reflection coefficients that represents the narrowband spectral envelope can be acquired from the voice signal. At step 440, the set of narrowband reflection coefficients can be extended to a set of wideband reflection coefficients using the mapping databases.

As an example, referring to FIG. 2, the feature extractor 222 can receive the re-sampled voice signal 105 and can perform a narrowband linear prediction analysis (LPC). In accordance with well-known principles of LPC, the feature extractor 222 can extract an envelope from the re-sampled voice signal 105. Because the re-sampled voice signal 105 is narrowband, the envelope, in general, is narrowband. The narrowband envelope can be represented by a set of LPC coefficients that describes an all-pole model approximation of the narrowband voice envelope.

The feature extractor 222 can generate a set of LPC coefficients, denoted by A(z). The narrowband converter 223 can convert the set of LPC coefficients into a set of reflection coefficients. Reflection coefficients may be useful in the inventive method because they may be more suitable for implementation of digital filters. Reflection coefficients may be more robust to noise in comparison to LPC coefficients, as well. Those of skill in the art will appreciate, however, that the invention is not so limited, as such a transformation may not be necessary and that other coefficient representations may be employed. In any event, the set of narrowband reflection coefficients can analogously represent the spectral envelope, albeit in a different mathematical form.

In addition, the reflection coefficients can be converted to a set of cepstral coefficients, which are also robust to numerical noise. Reflection coefficients are statistically dependent on each other, meaning that mutual information is contained within the individual coefficients of the set of reflection coefficients. Conversely, cepstral coefficients are statistically independent from one another with minimal mutual information between the coefficients. This independence is an important attribute for memory storage purposes and may be relevant with regard to the discussion below on mapping databases 210, 212 and 214. As such, the mapping database 210, 212 and 214 can be trained to support reflection coefficients or cepstral coefficients.

The envelope estimator 224 can perform the broad task of estimating a wideband spectral envelope from a narrowband spectral envelope. The envelope estimator 224 can receive as input, from the narrowband converter 223, a set of narrowband reflection coefficients that the envelope estimator 224 can present to the database selector 120. The database selector 120 can convert the set of narrowband reflection coefficients into a set of wideband reflection coefficients. Thus, the envelope estimator 224, through the database selector 120, can estimate a wideband spectral envelope from a narrowband envelope based on a non-linear transformation of the narrowband reflection coefficients using the selected mapping databases 210, 212 or 214.

For example, the database selector 120 can receive as input a set of narrowband reflection coefficients generated by the narrowband converter 223. Through statistical modeling, the database selector 120 can convert the set of narrowband reflection coefficients into a set of wideband reflection coefficients. The envelope estimator 224 can then pass the wideband reflection coefficients to the wideband converter 225, which can convert them into a set of wideband LPC coefficients. The LPC coefficients may be denoted by B(z), which can represent an all-pole approximation to a wideband spectral envelope.

As noted earlier, the database selector 120 can receive the selected sampling rate information from the evaluation section 110. The evaluation section 110 can identify a region of support based on system-supported sampling rates. The selected sampling rate may determine which mapping databases 210, 212 and 214 are selected by the database selector 120. As an example, the mapping databases 210, 212 and 214 may be Gaussian Mixture Models. It must be noted, however, that the mapping databases 210, 212 and 214 are not limited to this particular configuration. For example, those of skill in the art will appreciate that there are different ways to implement mapping functions, such as Vector Quantization or Hidden Markov Models.

GMMs can be useful in statistical modeling applications in which information that represents general characteristics or trends must be extracted from a large amount of data. Mapping functions such as GMMs are useful in gaining statistical insight of large quantities of data and for applying the statistical information. GMMs are known in the art, though a brief description will serve useful for illustrating the manner in which GMMs are applied for the conversion of a set of narrowband coefficients to a set of wideband coefficients.

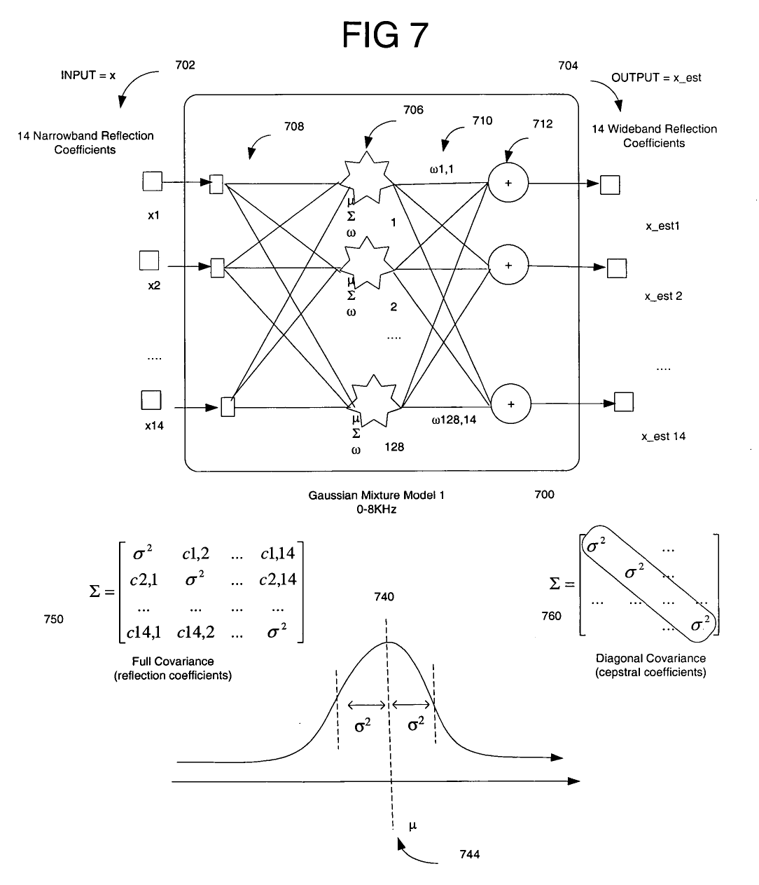

Referring to FIGS. 2 and 7, a set of narrowband coefficients provided by the feature extractor 222 can be submitted as input 702 to a GMM 700 through the database selector 120. The GMM 700 can represent one of the mapping databases 210, 212 or 214, for example. There can be fourteen input coefficients, denoted as X₁ through X₁₄, and fourteen corresponding output coefficients, denoted as X_est₁ through X_est₁₄, in the illustration of FIG. 7, though the GMM 700 can receive as input and output any suitable number of coefficients. The database selector 120 can decide which combination of GMMs 700 are to be used for mapping the set of reflection coefficients. The output of the GMM 700 will be a set of wideband coefficients 704, which represent the wideband spectral envelope. The GMM 700 can statistically determine a set of wideband coefficients that best represent the characteristics of a wideband envelope, given the submitted set of narrowband coefficients.

As is known in the art, a GMM attempts to determine an optimal transformation, known as mapping, which can be applied to an input signal to convert it to an output signal in accordance with the statistical information provided by the GMM. It should be noted that the GMM can provide statistical modeling capabilities based on a learning procedure called training, a process that is known in the art. In summary, a GMM is originally presented off-line with input and output training data to learn the statistics associated with the input to output data transformations. The GMM can employ an Expectation-Maximization (EM) algorithm to learn the mapping between the input and output set of coefficients.

Referring to FIG. 7, the GMM 700 can support a set of 128 Gaussians 706 where each Gaussian is represented by a set of parameters μ, Σ, ω describing the statistics of a single Gaussian 706. A single Gaussian 706 can represent a probability function that can be described by the equation below:

$$p ( x ) = \frac{1}{{( 2 π )}^{D / 2} {\vert \sum \vert}^{1 / 2}} exp \{ - \frac{1}{2} ( x - {{μ}^{′} ( \sum )}^{- 1} ( x - μ ) \}$$

where, x can be the reflection coefficient vector of length 14×1, μ is the average reflection coefficient vector of length, Σ is the covariance matrix of size 14×14 for the fourteen reflection coefficients, and D can be the dimension of the Gaussian 706, which is equal to the length of the x vector, which is 14.

Each Gaussian 706 can capture a portion of the total statistical information contained in the trained mappings between narrowband and wideband reflection coefficients. For example, the probability distribution of a single Gaussian 706 with dimension D=2 can be seen as the bell-curve 740. The Gaussian 706 can be a probability distribution function that describes a probability of observing an input reflection coefficient within the associated Gaussian 706. Each Gaussian 706 can provide a probability value for each reflection coefficient in the input represented as a likelihood measure for the Gaussian 706. In short, each input set of coefficients will be compared to each Gaussian 706, and each Gaussian 706 may provide some portion of statistical mapping information 708.

The probability information from each Gaussian 706 can be weighted 710 and added together 712 to instantiate the narrowband to wideband mapping. The term weighting in this context can mean that the probability information provided by each Gaussian 706 is multiplied by a weighted value. The mean vector, μ, and the covariance matrix, Σ, represent the statistics associated with each Gaussian 706.

A GMM 700 can support any number of Gaussians 706, though a GMM 700 that includes 128 Gaussians can provide adequate mapping capabilities for the set of reflection coefficients when sufficient statistical information is acquired from a large set of training data. It should also be noted that the set of reflection coefficients can be converted to a set of cepstral coefficients, which can be used with the GMM mapping. This conversion can reduce the amount of memory required by the GMM 700 because it can compress a Gaussian full covariance matrix to a diagonal vector of variances.

For example, the conversion may consist of a linear mathematical transformation that can convert a set of statistically dependent reflection coefficients to a set of statistically independent cepstral coefficients. A statistically dependent set of coefficients generally requires a full covariance matrix 750. A full matrix means that all of the terms in the matrix are used in the GMM 700. A statistically independent set of coefficients only generally requires the diagonal vector of a covariance matrix 760. A diagonal vector means that only the terms of the diagonal of the covariance matrix are used in the GMM 700. This process can reduce the number of covariance values that need to be stored in the GMM 700. For example, a size N×N covariance matrix can be reduced to a size N×1 vector, which can reduce the memory storage requirements of the GMM 700 by a factor of N.

Each of the fourteen reflection coefficients of the input 702 can be presented to each of the 128 Gaussians 706. Each Gaussian 706, for instance the 128^{th} Gaussian, can be characterized by its mean μ 744 and its covariance Σ 750, which together can describe the shape of the Gaussian probability function 740. A GMM 700 can be a group of 128 Gaussians that are mixed together based on the characteristics of the input signal. The 128 Gaussians 706 can be mixed together using a set of weightings ω 710 and an addition operation 712. The weightings ω 710 can be determined during training of an EM algorithm. For a 14-dimensional feature vector (i.e. 14 reflection coefficients), the mixture operation 712 used for the likelihood function can be:

$$p ( x ) = {\sum }_{i = 1}^{M} {w}_{i} {p}_{i} ( x )$$

which is a weighted linear combination of M=128 Gaussians 706 with mean vector μ and covariance matrix Σ₁. The mixture weights can be constrained to Σ₌₁^{M}wᵢ=1. The parameters of the density model can be λ={wᵢ, μᵢ, Σi}, where i=1, . . . M.

Once p(x) is found, the estimation for the set of wideband reflection coefficients can be determined as follows:

$$ρ ( x ) = \frac{{w}_{i} \cdot {p}_{i} ( x )}{ρ ( x / λ )}$$

$$x\_est = {\sum }_{j} ρ ( x ) \cdot ( {( {μ}_{j} - ( {x}^{′} - {μ}_{i} ) )}^{′} \cdot {( {\sum }_{ij} )}^{- 1} ( {\sum }_{ij}^{′} ) )$$

The above equation reveals the mapping properties of the GMM 700 expressed as an equation and relates the narrowband set of reflection coefficients as an input 702 to the GMM 700 to an output 704 representing the wideband set of reflection coefficients. The term p(x) can be determined by the GMM 700 (μᵢ is the i^{th} mean vector for the i^{th} Gaussian 706), and x (e.g., X₁ through X₁₄) represents the input set of narrowband reflection coefficients. Also, x_est (e.g., X_est₁ through X_est₁₄) reflects the estimated wideband set of reflection coefficients evaluated for the input set of narrowband reflection coefficients. The mathematical operations of the GMM mapping described above can be accomplished by the envelope estimator 224 and the database selector 120 of FIG. 2, in accordance with step 440 of FIG. 4.

Referring back to FIG. 5, at step 442, a wideband spectral excitation can be created from the wideband spectral envelope and the voice signal. An example of this process is presented in steps 444 through 448. At step 444, a narrowband spectral excitation can be extracted from the voice signal using the set of wideband reflection coefficients or a set of narrowband LPC coefficients, as provided in step 440. At step 446, the narrowband excitation signal can be extended to a wideband excitation signal. An example of how such a process can be performed is shown in steps 448A-448F.

Specifically, at step 448A, a low-band excitation can be generated, and at step 448B, a high-band excitation can be generated. For example, at option step 448C, the low-band excitation and the high-band excitation can be modulated using a cosine multiplication. At option step 448D, the low-band excitation and the high-band excitation can be filtered. At step 448E, the low-band excitation and the high-band excitation can be added with the narrowband excitation (or passband excitation) to create a half-band excitation. At step 448F, a wideband excitation can be generated from the half-band excitation.

For example, referring to FIG. 2, the wideband analysis section 242 can generate the narrowband excitation by inverse filtering the re-sampled voice signal 105 with a set of reflection coefficients. The inverse filtering may require the set of wideband coefficients presented by the envelope estimator 224, or alternatively, it can use the narrowband LPC coefficients generated at the feature extractor 222. Either the narrowband or wideband set of coefficients can be used within the wideband analysis section 242 for generating the narrowband excitation. Inverse filtering the re-sampled voice signal 105 with either set of coefficients can generate a narrowband excitation signal because the re-sampled voice signal 105 is itself narrowband.

The narrowband excitation can be passed though the multi-path excitation stage 244 to create a wideband excitation. The purpose of the multi-path excitation stage 244 is to create an artificial excitation signal within the region of support 636 (see FIG. 6). It may be considered artificial in the sense that the supplemental excitation can be generated by replication and shifting of the re-sampled narrowband excitation signal.

Referring now to FIGS. 2, 3 and 6, the multi-path excitation stage 244 can receive the narrowband excitation from the wideband analysis section 242. The narrowband excitation can diverge through various paths that can build upon, or extend, the received narrowband excitation. For example, the narrowband excitation can pass through the low-band excitation stage 310, the high-band excitation stage 320, and the pass-band excitation stage 330.

The modulator 312 of the low-band excitation stage 310 can modulate the narrowband excitation to, for example, a region occurring in the lower frequency region of support 633 (e.g., 0 Hz to 300 Hz). The modulator 322 of the high-band excitation stage 320 can modulate the narrowband excitation to a region occurring in a portion of the higher frequency upper region of support 637 (e.g., 3.4 KHz to 4 KHz). As an example, a cosine multiplication can be used to modulate the narrowband excitation signal to regions of support 633, 637 described above.

The low-pass filter 314 of the low-band excitation stage 310 can remove the aliased components due to modulation. Similarly, the band-pass filter 324 of the high-band excitation stage 320 can remove the aliased components caused by the modulation. The pass-band excitation stage 330 can allow the narrowband excitation to pass unprocessed, which can permit it to remain within its original bandwidth (e.g., 300 Hz to 3.4 KHz).

The adder 340 can sum together the low-band, high-band, and pass-band excitations to generate a half-band excitation, which can extend from 0 Hz to 4 KHz based on our example. Next, the modulator 350, using a cosine multiplication, for example, can modulate the half-band excitation to create a full-band or wideband excitation. The modulation of the half-band excitation to a wideband excitation may correspond to the frequencies from 4 KHz to 8 KHz. Upon completion of the multi-path excitation stage 244, the narrowband excitation signal may be extended to a wideband excitation signal.

It should be noted that the low-band modulator 312, the high-band modulator 322 and the half-band modulator 350 are not restricted to modulating data to only the region of support 636. For example, it may be necessary to have some overlap in the shifting at the boundaries of the region of support 636. Through this overlap, the frequency response of the wideband excitation signal can be spectrally flat, a desirable characteristic, as is known in the art.

Referring back to the method 400 of FIG. 5, at step 450, a wideband voice signal can be generated by combining the created wideband spectral envelope together with the created wideband excitation and the voice signal. Steps 452-456 present an example of how this process can be done. In particular, the wideband envelope provided by step 436 can be combined with the wideband excitation provided by step 442 to generate a synthetic wideband voice signal, as shown at step 452. The synthetic wideband voice signal can contain spectral content within the region of support and also the original unknown voice bandwidth.

At step 454, a supplemental wideband voice signal can be extracted from the synthetic wideband voice signal in the region of support. The spectral content in the synthetic wideband voice signal that represents the same frequency region of the original unknown voice bandwidth can be removed, if the original unknown voice signal is be combined with the supplemental wideband voice signal. This step may be executed because it is not necessary to duplicate the original spectral content of the voice signal. At step 456, the supplemental wideband voice signal can be added to the voice signal to generate a wideband voice signal. The method 400 can end at step 458.

As an example and referring to FIGS. 2 and 6, the mixing processor 260 can mix a supplemental wideband voice signal with the re-sampled voice signal 105 to generate a wideband voice signal. The supplemental wideband voice signal can be extracted from a synthetic wideband voice signal. For example, the wideband synthesis section 262 can use the wideband LPC coefficients provided by the wideband converter 225 as synthesis filter coefficients. The wideband synthesis section 262 can also receive as input the wideband excitation signal provided by the multi-path excitation stage 244. The wideband synthesis section 262 can generate a synthetic wideband voice signal by filtering the wideband excitation signal with Wideband LPC filter coefficients. The resulting voice signal is a synthetic wideband voice signal. In our example, the synthetic wideband voice signal can extend from 0 Hz to 8 KHz.

As previously mentioned, spectral content can be selectively removed from the synthetic wideband voice signal to generate a supplemental wideband voice signal. The supplemental wideband voice signal can be generated by passing a synthetic wideband voice signal through the band-stop filter 264. The band-stop filter 264 can suppress spectral content outside or within the region of support 636.

Specifically, the original unknown voice signal already provides spectral content within the voice bandwidth 625 (e.g., 300 Hz to 3.4 KHz). Because the synthetic wideband voice signal also contains spectral content that corresponds to spectral content contained within the voice bandwidth 625, the band-stop filter 264 can suppress the spectral content in the synthetic wideband voice signal that overlaps the spectral content of the re-sampled voice signal 105. Thus, the unknown voice signal may only need supplemental spectral content outside its own bandwidth (e.g., 0-300 Hz and 3.4 KHz to 8 KHz). The adder 266 can add the supplemental wideband voice signal with the re-sampled voice signal 105 to generate the wideband voice signal.

Where applicable, the present invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present invention may also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for bandwidth extension for voice communications, comprising:
receiving an unknown voice signal;
identifying the voice bandwidth of the received unknown voice signal;
establishing a region of support in view of the spectral content of the received voice signal; and
selecting a combination of mapping databases from a plurality of mapping databases, each mapping database associated with a predetermined bandwidth extension range for extending the voice bandwidth.

2. The method according to claim 1, wherein identifying the voice bandwidth includes performing a spectral analysis to determine the voice signal bandwidth of the unknown voice signal based on a spectral energy of the signal.

3. The method according to claim 1, wherein establishing a region of support comprises:
issuing a request to an underlying object to return a list of sampling frequencies for which the object is capable of supporting;
identifying spectral limits based on the returned sampling frequency; and
determining spectral bands within the spectral limits for extending the voice bandwidth to regions that reside outside the voice bandwidth.

4. The method according to claim 3, wherein establishing a region of support further comprises re-sampling the voice signal at a sampling frequency corresponding to at least one of the returned sampling frequencies.

5. The method according to claim 1, wherein selecting a combination of mapping databases is a sequential operation and further comprises applying a serial combination of mapped databases to collectively extend the voice bandwidth to a range corresponding to the addition of the selected bandwidth extension ranges.

6. The method according to claim 5, wherein there is a first mapping database for the range approximately 0 to approximately 8 KHz, a second mapping database for approximately 8 KHz to approximately 16 KHZ and a third mapping database for approximately 16 KHz to approximately 22 KHz, and the three mapping databases are Gaussian Mixture Models.

7. The method according to claim 1, further comprising:
acquiring a set of narrowband reflection coefficients that represent the spectral envelope from the voice signal; and
extending the set of narrowband reflection coefficients to a set of wideband reflection coefficients using the mapping databases for generating a wideband spectral envelope.

8. The method according to claim 7, wherein the set of narrowband reflection coefficients is converted to a set of cepstral coefficients for reducing a memory storage by compressing a Gaussian full covariance matrix to a diagonal vector of variances.

9. The method according to claim 1, further comprising:
extracting a narrowband excitation signal from the voice signal using a set of wideband reflection coefficients or a set of narrowband linear prediction analysis coefficients; and
extending the narrowband excitation signal to a wideband excitation signal using modulation and filtering.

10. The method according to claim 1, further comprising:
combining a wideband excitation signal with a wideband spectral envelope to generate a synthetic wideband voice signal;
extracting a supplemental wideband voice signal from the synthetic wideband voice signal in the region of support; and
adding the supplemental synthetic wideband voice signal with the voice signal to generate a wideband voice signal.

11. A method of extending a set of narrowband reflection coefficients to a set of wideband coefficients for use in voice bandwidth extension, comprising:
generating a low-band excitation;
generating a high-band excitation;
adding the low-band excitation and the high-band excitation with a narrowband excitation to create a half-band excitation; and
generating a wide-band excitation from the half-band excitation.

12. The method of claim 11, wherein generating the low-band excitation and the high-band excitation further comprises:
modulating the low-band excitation and the high-band excitation using a cosine multiplication; and
filtering the low-band excitation and the high-band excitation.

13. A machine readable storage, having stored thereon a computer program having a plurality of code sections executable by a portable computing device for causing the portable computing device to perform the steps of:
receiving an unknown voice signal;
identifying the voice bandwidth of the received unknown voice signal;
establishing a region of support in view of the spectral content of the received voice signal; and
selecting a combination of mapping databases from a plurality of mapping databases, each mapping database associated with a predetermined bandwidth extension range for extending the voice bandwidth.

14. The machine readable storage of claim 13, wherein the code sections executable by a portable computing device further cause the portable computing device to perform the steps of:
combining a wideband excitation signal with a wideband spectral envelope to generate a synthetic wideband voice signal
extracting a supplemental synthetic wideband voice signal from the synthetic wideband voice signal in the region of support; and
adding the supplemental synthetic wideband voice signal with the unknown voice signal to generate a wideband voice signal.

15. The machine readable storage of claim 13, wherein the code sections executable by a portable computing device further cause the portable computing device to perform the steps of:
extracting a narrowband excitation signal from the voice signal using a set of wideband reflection coefficients or a set of narrowband linear prediction analysis coefficients; and
extending the narrowband excitation signal to a wideband excitation signal using modulation and filtering.

16. The machine readable storage of claim 13, wherein the code sections executable by a portable computing device further cause the portable computing device to perform the steps of:
acquiring a set of narrowband reflection coefficients that represent the spectral envelope from the voice signal; and
extending the set of narrowband reflection coefficients to a set of wideband reflection coefficients using the mapping databases for generating a wideband spectral envelope.

17. The machine readable storage of claim 13, wherein the code sections executable by a portable computing device further cause the portable computing device to perform the steps of:
generating a low-band excitation;
generating a high-band excitation;
adding the low-band excitation and the high-band excitation with the narrowband excitation to create a half-band excitation; and
generating a wide-band excitation from the half-band excitation.

18. A system for artificially extending the bandwidth of voice, comprising:
an evaluation section that receives an unknown voice signal and determines an allowable extent of voice bandwidth for the unknown voice signal;
a database selector cooperatively coupled to the evaluation section, wherein the database selector chooses a combination of mapping databases according to the allowable extent of voice bandwidth; and
a bandwidth extension unit cooperatively coupled to the evaluation section and the database selector, wherein the bandwidth extension unit extends the voice bandwidth of the unknown voice signal to the allowable extent of voice bandwidth using the combination of mapping databases chosen by the database selector.

19. The system of claim 18, wherein the evaluation section comprises:
an analysis module that identifies a voice bandwidth associated with the unknown voice signal;
an inquiry module cooperatively coupled to the analysis module, wherein the inquiry module identifies supported sampling rates, wherein the supported sampling rates reveal the extent to which the voice bandwidth can be extended; and
a sampling module cooperatively coupled to the analysis module and the inquiry module, wherein the sampling module re-samples the unknown voice signal at one of the supported sampling rates identified by the inquiry module, wherein the re-sampling prepares the voice signal for bandwidth extension.

20. The system of claim 18, wherein the mapping databases are Gaussian Mixture Models that provide continuous mapping functions, and each Gaussian Mixture Model has its own covariance matrix, mean vector, and set of probability weights.

21. The system of claim 18, wherein the bandwidth extension unit comprises:
an envelope processor cooperatively coupled to the evaluation section and the database selector, wherein the envelope processor determines a narrowband spectral envelope from the voice signal and subsequently provides a set of wideband coefficients representing a wideband spectral envelope;
an excitation processor cooperatively coupled to the evaluation section and the envelope processor, wherein the excitation processor determines a narrowband excitation signal from the voice signal using a set of wideband reflection coefficients or a set of narrowband linear prediction analysis coefficients and subsequently creates a wideband excitation signal; and
a mixing processor cooperatively coupled to the evaluation section, the envelope processor and the excitation processor, wherein the mixing processor combines the voice signal together with the wideband excitation signal and the wideband spectral envelope for creating a wideband voice signal.

22. The system of claim 21, wherein the envelope processor comprises:
a feature extractor that acquires a set of linear prediction analysis coefficients that represent the spectral envelope of the voice signal;
a narrowband converter communicatively coupled to the feature extractor, wherein the narrowband converter converts the set of linear prediction analysis coefficients into a set of narrowband reflection coefficients;
an estimator communicatively coupled to the narrowband converter, wherein the estimator, in conjunction with the database selector, extends the set of narrowband reflection coefficients to a set of wideband reflection coefficients using the mapping databases; and
a wideband converter communicatively coupled to the estimator, wherein the wideband converter converts the wideband reflection coefficients into a set of wideband linear prediction analysis coefficients.

23. The system of claim 21, wherein the excitation processor comprises:
an analysis section that extracts a narrowband excitation signal from the voice signal using a set of wideband or narrowband linear prediction analysis coefficients;
a low-band excitation stage communicatively coupled to the analysis section, wherein the low-band excitation stage generates a low-band excitation from the narrowband excitation signal;
a high-band excitation stage communicatively coupled to the analysis section, wherein the high-band excitation stage generates a high-band excitation from the narrowband excitation signal;
an adder communicatively coupled to the low-band and high band excitation stages, wherein the adder adds the low-band excitation and the high-band excitation with a pass-band excitation to create a half-band excitation; and
a modulator communicatively coupled to the adder, wherein the modulator generates a full-band excitation from the half-band excitation.

24. The system of claim 18, wherein the system further comprises a receiver or a transmitter, and the system is part of a mobile communications unit.
